(19) United States
(12) Patent Application Publication
(10) Pub. No.: US 2015/0085894 A1
(43) Pub. Date: Mar. 26, 2015

(54) METHOD FOR DIAGNOSING FAULT WITHIN A FUEL VAPOR SYSTEM

(71) Applicant: FORD GLOBAL TECHNOLOGIES, LLC, Dearborn, MI (US)

(72) Inventors: DENNIS SEUNG-MAN YANG, CANTON, MI (US); AED M. DUDAR, CANTON, MI (US)

(73) Assignee: FORD GLOBAL TECHNOLOGIES, LLC., Dearborn, MI (US)

(21) Appl. No.: 14/035,900

(22) Filed: Sep. 24, 2013

(51) Int. Cl. G01N 25/72

(52) U.S. Cl. CPC G01N 25/72
USPC 374/4

(57) ABSTRACT

A method for diagnosing a fault within a evaporative emission control system of an automotive vehicle. The method monitors the carbon canister temperature during a system leak test. The leak test here is undertaken with the engine running, and engine vacuum is employed to evacuate the EVAP system. If the evacuation succeeds in reaching a target vacuum, and a temperature gain in the canister is observed, then the system infers proper system operation. Failure to achieve a target vacuum causes the system to determine a likely cause of the failure based on the temperature response of the carbon canister.

### TECHNICAL FIELD

Embodiments of the present disclosure generally relate to methods and systems for detecting leakage within EVAP systems, and, more specifically, to methods and systems for identifying the cause of leakage within EVAP systems.

### BACKGROUND

Gasoline, used as an automotive fuel in many automotive vehicles, is a volatile liquid subject to potentially rapid evaporation in response to diurnal variations in the ambient temperature. Thus, the fuel contained in automobile gas tanks presents a major source of potential emission of hydrocarbons into the atmosphere. Such emissions from vehicles are termed ‘evaporative emissions’, and those vapors can be emitted even when the engine is not running

In response to this problem, industry has incorporated evaporative emission control systems (EVAP) into automobiles. EVAP systems include a “carbon canister” containing adsorbent carbon pellets that trap fuel vapor by adsorbing it onto the pellets. Periodically, a purge cycle feeds the captured vapor to the intake manifold for combustion, thus reducing evaporative emissions.

Hybrid electric vehicles, including plug-in hybrid electric vehicles (HEV's or PHEV's), pose a particular problem for effectively controlling evaporative emissions. Although hybrid vehicles have been proposed and introduced in a number of forms, these designs all provide a combustion engine as backup to an electric motor. Primary power is provided by the electric motor, and careful attention to charging cycles can produce an operating profile in which the engine is only run for short periods. Careful users can achieve results in which the engine is only operated once or twice every few weeks. Purging the carbon canister can only occur when the engine is running, of course, and if the canister is not purged, the carbon pellets can become saturated, after which hydrocarbons will escape to the atmosphere, causing pollution.

Leaks can occur in an EVAP system, however, leading to problems, problems in carrying out the functions such as purging without discharging hydrocarbons into the atmosphere. C. Vehicles are required to implement diagnostics that check for leaks of at least 0.040″, and some states require testing for leaks down to 0.020″. One method for performing leak diagnostics employs an on-board pump that evacuates the EVAP system; measuring any ensuing vacuum bleed-up identifies any possible system leaks. Knowing that a leak is present, however, does not materially assist in curing the problem.

Thus, the art does not provide a method that will both determine whether a leak exists and point the way to a probable cause.

### SUMMARY

According to an aspect of the disclosure, the present disclosure provides a method for diagnosing a fault within an evaporative emission control system of an automotive vehicle. The method monitors the carbon canister temperature though a temperature sensor, during a system leak test. If the fuel vapor system fails to achieve a target vacuum during the leak test, the method generates a temperature response of the carbon canister. Further, the method infers a likely cause of the failure based on the temperature response of the carbon canister. If the temperature decreases, then the method concludes a fault due to an open canister vent valve or a leakage port within a first communication line. If the temperature increases, then the method concludes a fault due to a leakage port within a fuel tank, or a leakage port within a second communication line. If the temperature remains substantially constant, then the method concludes a fault sue to a closed canister purge valve or a leakage port within a third communication line.

Additional aspects, advantages, features and objects of the present disclosure would be made apparent from the drawings and the detailed description of the illustrative embodiments construed in conjunction with the appended claims that follow.

### BRIEF DESCRIPTION OF THE DRAWINGS

FIG. 1 is a schematic representation of an evaporative emission control system of a vehicle, according to an aspect of the present disclosure.

FIG. 2 is a flowchart describing a method for diagnosing a fault within an evaporative emission control (EVAP) system.

FIGS. 3A and 3B are graphs illustrating the temperature response and pressure response in case of no fault-in the EVAP system of the present disclosure.

FIGS. 4A and 4B are graphs illustrating the temperature response and pressure response in case of a fault due to a leakage port in the fuel tank or a broken communication line on the fuel tank side.

FIGS. 5A and 5B are graphs illustrating the temperature response and the pressure response in case of a fault due to an open canister vent valve or a broken vent line.

FIGS. 6A and 6B are graphs illustrating the temperature response and the pressure response in case of a fault due to a closed CPV or a broken purge line.

### DETAILED DESCRIPTION OF ILLUSTRATIVE EMBODIMENTS

The following detailed description illustrates aspects of the disclosure and its implementation. This description should not be understood as defining or limiting the scope of the present disclosure, however, such definition or limitation being solely contained in the claims appended hereto. Although the best mode of carrying out the invention has been disclosed, those in the art would recognize that other embodiments for carrying out or practicing the invention are also possible.

In general, the present disclosure capitalizes upon the fact that the adsorption of hydrocarbon vapor in the pellets of the carbon canister is an exothermic reaction. The opposite is true, of course, when a fresh air flow through the carbon canister entrains hydrocarbons from the carbon pellets, resulting in a drop in canister temperature. It has thus been discovered that one can infer the cause of a vacuum test failure by monitoring the canister temperature.

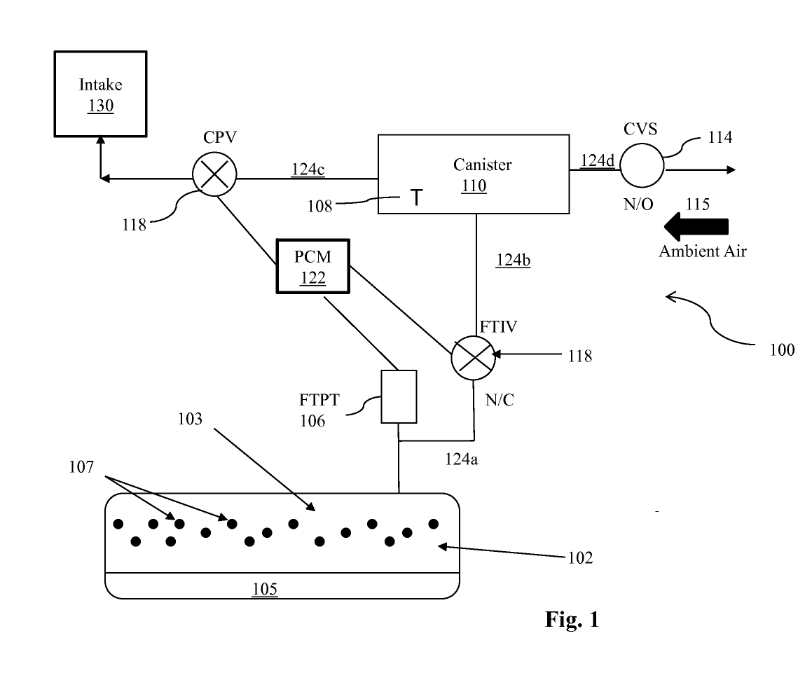

FIG. 1 illustrates a conventional evaporative emission control system 100 of a PHEV. As seen there, the system 100 is made up primarily of the fuel tank 102, a carbon canister 110, and the engine intake manifold 130, all joined by communication lines 124a. It will be understood that many variations on this design are possible, but the illustrated embodiment follows the general practice of the art. It will be further understood that the system 100 is generally sealed, with no open vent to atmosphere.

Fuel tank 102 is partially filled with liquid fuel 105, but a portion of the liquid evaporates over time, producing fuel vapor 107 in the upper portion (vapor dome 103) of the tank. The amount of vapor produced depends upon a number of environmental variables, such as the ambient temperature. Of these factors, temperature is probably the most important, particularly given the temperature variation produced in the typical diurnal temperature cycle. For vehicles in a sunny climate, particularly a hot, sunny climate, the heat produced by leaving a vehicle standing in direct sunlight can produce very high pressure within the vapor dome. A fuel tank pressure transducer (FTPT) 106 monitors the pressure in the fuel tank vapor dome 103.

Vapor lines 124 join the various components of the system. One portion of that line, line 124a runs from the fuel tank 102 to carbon canister 110. A normally-closed fuel tank isolation valve (FTIV) 118 regulates the flow of vapor from fuel tank 102 to the carbon canister 110, so that vapor generated by evaporating fuel can be adsorbed by the carbon pellets. Vapor line 124b joins line 124a in a T intersection on the canister side of the FTIV 118, connecting that line with a normally closed canister purge valve (CPV) 126. Line 124c continues from CPV 126 to the engine intake manifold 130. A powertrain control module (PCM) 122 controls the operations of CPV 126 and FTIV 118. Also, PCM 122 receives input signals from FTPT 106 and other sensors as mentioned below. PCM 122 can be a standalone element, but in the illustrated embodiment it is part of the overall vehicle control system, which performs a variety of functions for the automobile. As such, PCM 122 is capable of commanding operational signals, such as opening and closing valves, as well as calculations and data storage functions.

Canister 110 is connected to ambient atmosphere at vent 115, through a normally closed valve 114. Vapor line 124d connects that 115 in canister 110. Valve 114 is controlled by PCM 122.

During normal operation, valves 118, 126, and 114 are closed. When pressure within vapor dome 103 rises sufficiently, under the influence, for example, of increased ambient temperature, the PCM opens valve 118, allowing vapor to flow to the canister, where carbon pellets can adsorb fuel vapor.

To purge the canister 110, FTIV 118 is closed, and valves 126 and 114 are opened. It should be understood that this operation is only performed when the engine is running The vacuum present in intake manifold 130 causes an airflow from ambient atmosphere through vent 115, canister 110, and CPV 126, and then onward into intake manifold 130. As the airflow passes through canister 110, it entrains fuel vapor from the carbon pellets. The resulting fuel vapor/air mixture proceeds to the engine, where it is mixed with the primary fuel/air flow to the engine for combustion.

The canister 110 includes a temperature sensor 108, positioned to measure the temperature within the canister 110. Temperature sensor 108 is connected to PCM 122. Operation of these devices will be discussed below.

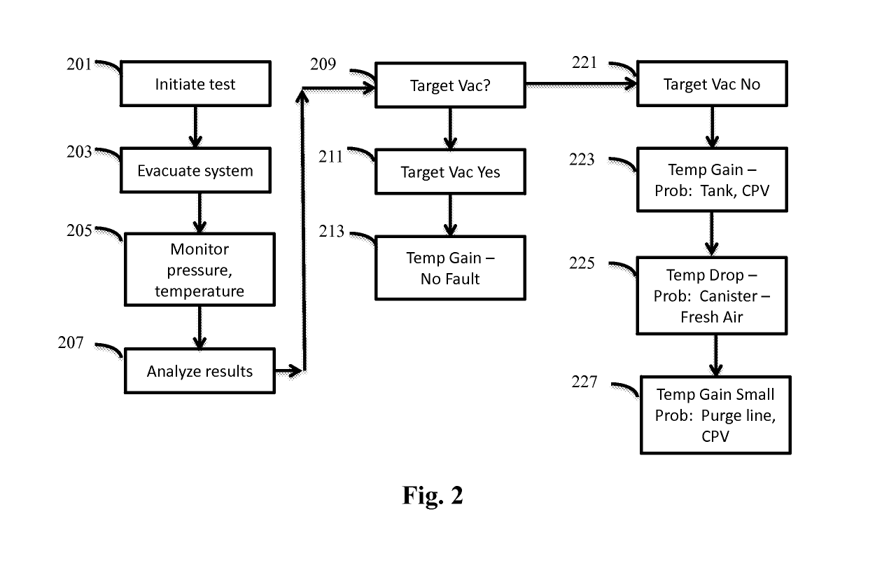

FIG. 2 is a flowchart describing a method for diagnosing a fault within the evaporative emission control system 100. It will be understood that device references will refer to the system depicted in FIG. 1. The method initiates at a time when the engine is running and the vehicle is proceeding at a steady rate of about 40 mph. It will be understood that these initiation conditions imply that this test cannot be simply conducted under complete the automated control; a degree of driver participation is required. where

At step 203, the evaporative emission control system 100 is evacuated to a target vacuum. Those in the art will understand that a variety of vacuum levels can be employed, but a reasonable target vacuum can be about −8″ H₂O. In the illustrated embodiment, the system 100 is evacuated using engine vacuum, normally present in the intake manifold. To create the target vacuum the CPV 126, is opened, subjecting the EVAP system to the vacuum generated by the engine. To ensure the creation of a vacuum, the canister vent valve (CVV) 114, located between the canister 110 and the vent 115, is closed. At the same time, FTIV 118 is opened, opening a flow path between the fuel tank 102 and the canister 110. In step 205, PCM 122 monitors signals from the FTPT 106 and the temperature sensor 108. It will be useful if the monitoring commences just prior to setting the valves as noted above, ensuring that the system obtains a good reading for the beginning canister temperature. The evacuation proceeds for a set amount of time, sufficient to ensure achieving the target level of vacuum, provided the system operates properly. Those of skill in the art will understand how to select the time factors for this test.

In step 207, the method analyzes the results obtained from the test, after the selected time has elapsed. The basic question, set out in step 209, is whether the evacuation step has succeeded in reaching the target vacuum. If the target vacuum is reached, as shown in step 211, then the question is whether a temperature gain was observed. Given that the target vacuum was achieved, the only flow through the EVAP system necessarily occurred from fuel tank 102, through FTIV 118 and onward through canister 110, continuing through CPV 118 and onto the intake manifold 130. Vapor flowing through canister 110 would at least in part be adsorbed by carbon pellets, resulting in an increase in temperature. Thus, an increase in temperature, coupled with achievement of the target vacuum indicates that the system is operating without fault, as reflected in step 213. An increase in temperature corresponds to Compares the pressure response with the pre-stored pressure response to determine whether the evacuation succeeded in reaching a target vacuum level. It accurate system.

If the target vacuum level is not achieved, then the analysis carried out by PCM 122 can infer the likely source problem, based on the temperature monitored by temperature sensor 108. In this situation, one would expect a flow vapor through canister 110 to produce a temperature gain, while a flow of air would produce a temperature drop, due to the fact that airflow into the canister would entrain fuel vapor from the pellets, an endothermic reaction. In general, it can be said that the system will observe a temperature gain, a temperature drop, or little to no change. The first of those conditions is set out in step 223, which is executed if the system identifies a temperature gain during the test. Here, the fact of a temperature gain means that vapor is flowing from the fuel tank 102 through the canister 110, in spite of the fact that the desired vacuum level has not been reached. That fact leads to an inference that the reason for the failure to achieve the target vacuum is most likely a hole in the fuel tank 102, or an insufficient flow through CPV 126. Both of those items should be subjected to a thorough maintenance inspection.

The situation of observing a temperature drop coupled with failure to achieve the target vacuum is shown in step 225. Here one can infer that fresh air, not fuel vapor, is flowing through the canister 110. The suspects in this case include an open CVS 114, or some other leak between the canister and fresh air vent 115.

Finally, if one observes little or no temperature change, shown at step 227, one can conclude that little or no flow is occurring through canister 110, most likely owing to a fault with CPV 126 or a block in purge line 124c.

The advantage of the present disclosure is immediately apparent, in that the system not only can identify the presence of a leak, but it can make an informed inference of the likely cause. As a result, a maintenance investigation can be considerably shortened, because the technician can start from a position of knowledge, rather than working from a blank slate.

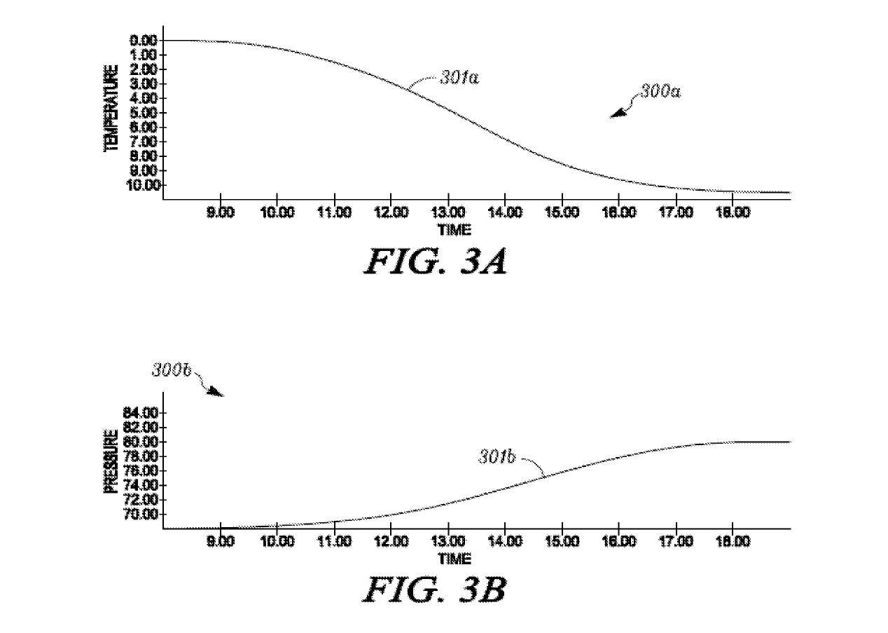

FIG. 3 includes two graphs 300a and 300b. The graph 300a illustrates the temperature response 301a of a temperature sensor 108, and the graph 300b illustrates the pressure response 301b of a FTPT 106, in case of no fault in the EVAP system 100. The EVAP system 100 is evacuated to a target vacuum (−81nH₂O). The system 100 is evacuated by closing the CVV 114 and opening the CPV 126 and the valve 118, and running the vehicle at at a minimum steady state speed of 40 mph. In case of no fault in the EVAP system 100, the pressure response 301b of the FTPT 106 decreases to the target vacuum. As the vehicle is running, the fuel evaporates from the fuel tank 102. The fuel vapors are routed to the canister 110 through the FTIV 118. The carbon pellets present in the canister 110 adsorb the fuel vapors. The adsorption of the fuel vapors in the canister 110 results in an increase in temperature within the canister 110. The temperature graph 300a shows an increase in the temperature with time. The temperature response 301a and the pressure response 301b are pre-stored in the control module, for comparison with other responses for the diagnosis of faults.

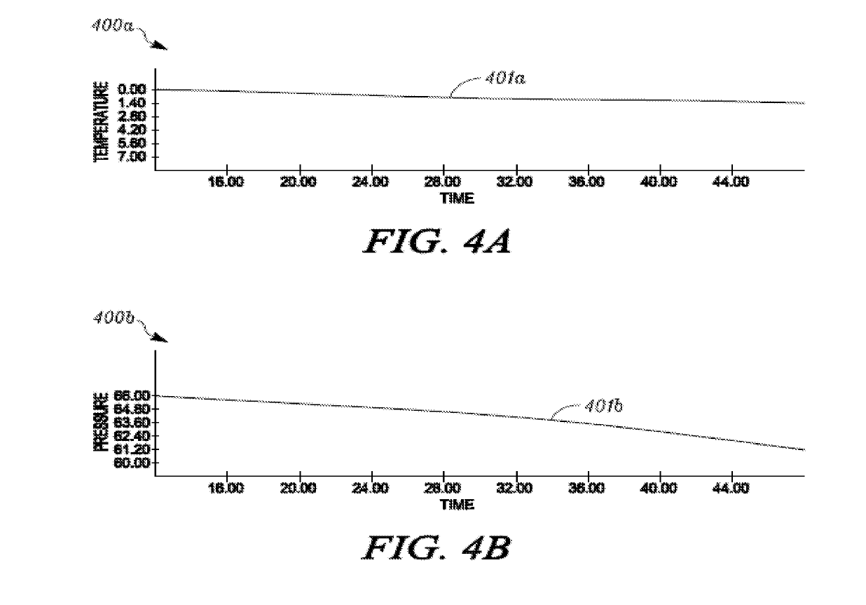

FIG. 4 includes graphs 400a and 400b. The graph 400a illustrates the temperature response 401a of the temperature sensor 108, and the graph 400b illustrates the pressure response 401b of the FTPT 106, in case of a fault due to a leakage port in the fuel tank or a leakage port in the vapor line 124a. A leakage port in the fuel tank 103 or in the communication line 124a results in a failure to pull down the system 100 to the target vacuum of −81nH₂O. Therefore, the pressure response 401b of the FTPT 106 is a substantially constant curve, as shown. The fuel vapor 107 in the fuel tank 102 flows into the canister 110 through the valve 118. The carbon pellets in the canister 110 adsorb the fuel vapor 107. The adsorption of fuel vapor results in a heat gain within the canister. This heat gain results in a temperature rise, as illustrated by the graph 400a.

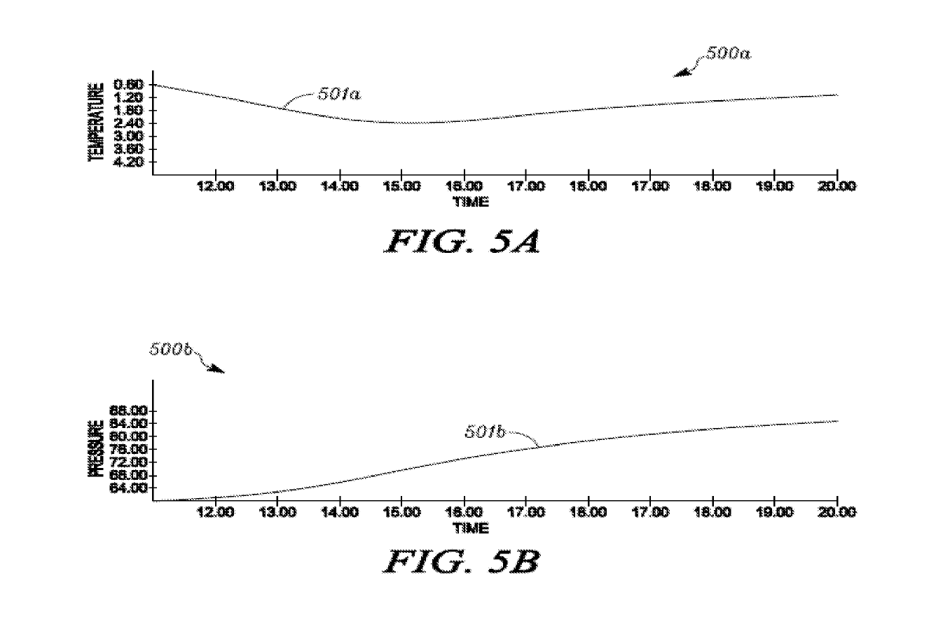

FIG. 5 includes two graphs 500a and 500b. The graph 400a illustrates the temperature response 401a of the temperature sensor 108, and the graph 400b illustrates the pressure response 401b of the FTPT 106, in case of a fault due to an open CVV 114 or a leakage port in the communication line 124d. An open CVV 114 or a leakage port in the communication line 124d results in a failure to pull down the system 100 to the target vacuum, as fresh air flows into the system 100 through the leakage ports. This results in a cooling effect within the canister 110, as fresh air flows in from the vent 115, through CVV 114, and into the canister 110. Therefore, there is a temperature drop, as shown in the graph 500a.

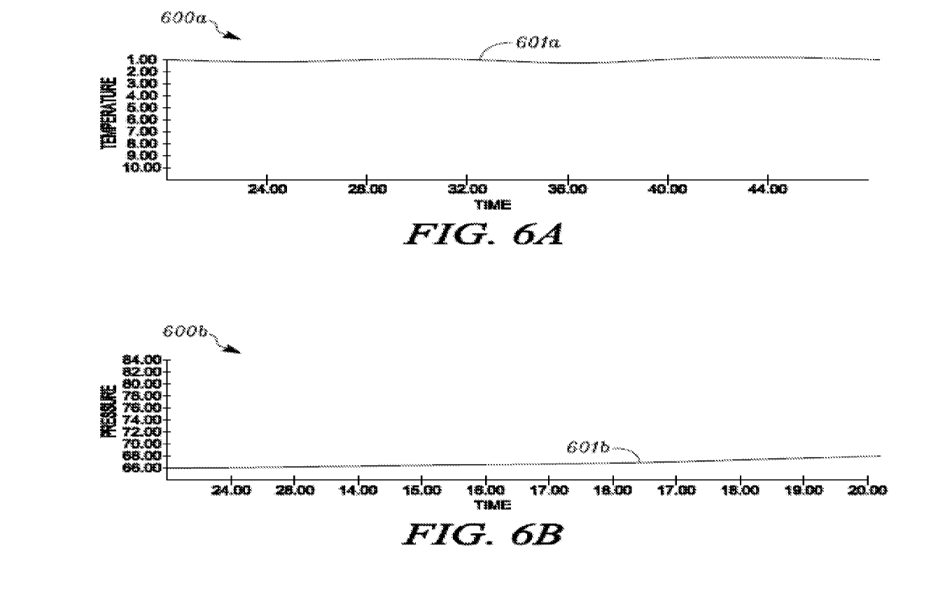

FIG. 6 includes two graphs 600a and 600b. The graph 600a illustrates the temperature response 601a of the temperature sensor 108, and the graph 600b illustrates the pressure response 601b of the FTPT 106, in case of a fault due to a closed CPV 126 or a leakage port in the communication line 124b. A closed CPV 126 or a leakage port in the communication line 124b results in a failure to pull down the system to the target vacuum −81nH₂O. Therefore, the pressure response 601b is a substantially constant curve, as shown. This type of fault results in the canister 110 not being able to purge the vapor into the engine 130. Therefore, the fuel vapor from the fuel tank 103 is not adsorbed into the canister 110. As a result, there is little or no temperature rise within the canister 110. Therefore, the temperature response 601a is a substantially constant curve, as shown.

What is claimed is:

1. A method for diagnosing a fault in an evaporative emission control system, comprising:
during a system leak test, monitoring carbon canister temperature;
upon identifying a failure to achieve a target vacuum during a leak test, determining the carbon canister temperature change during the test; and
inferring a likely cause of the failure based on a comparison of the temperature change and predetermined data.

2. The method of claim 1, wherein the fuel vapor system is evacuated to a target vacuum during the leak test, while the engine is running at a pre-determined speed.

3. The method of claim 1, wherein the temperature within the carbon canister is measured through a temperature sensor.

4. The method of claim 3, wherein the temperature sensor is connected to a control module.

5. The method of claim 4, wherein the control module generates a temperature response during the test, and displays it on a user interface.

6. The method of claim 1, wherein the fault is due to a canister vent valve being leaky, or due to a leakage port in a first communication line, if the temperature within the carbon canister decreases.

7. The method of claim 1, wherein the fault is due to a leakage port in a fuel-tank of the vehicle or a second communication line, if the temperature within the carbon canister increases.

8. The method of claim 1, wherein the fault is due to a canister purge valve being stuck closed, or due to a leakage port existing in a third communication line, if the canister temperature within the carbon canister remains substantially constant.
